(19) United States
(12) Patent Application Publication
(10) Pub. No.: US 2023/0234081 A1
(43) Pub. Date: Jul. 27, 2023

(54) FLUID CONTROL STRUCTURE OF DISPENSING APPARATUS

(71) Applicant: ADVANCED JET AUTOMATION CO., LTD, New Taipei City (TW)

(72) Inventor: Lu-Min Chen, Taipei City (TW)

(21) Appl. No.: 17/695,818

(22) Filed: Mar. 15, 2022

(30) Foreign Application Priority Data
Jan. 24, 2022 (TW) 111102826

(51) Int. Cl. B05B 1/30; F16K 1/38

(52) U.S. Cl. CPC B05B 1/3046; F16K 1/385

(57) ABSTRACT

The present invention discloses a fluid control structure of a dispensing apparatus, comprising: a dispensing unit, a fluid supply unit, and a control unit. The present invention is characterized by its dispensing apparatus which includes a needle head, a thimble, and a valve body, wherein the valve body is provided with an accommodating space for accommodating the needle head and the thimble. The needle head is being formed a hollow space, and the space is tapered towards the direction of a nozzle, the nozzle disposed at one end of the needle head; the thimble is moved up and down along the valve body, having the same tapered as the inner diameter of the needle head. The fluid control structure of the dispensing apparatus of the present invention is to solve the shortcoming of prior art that the residual pressure in the dispensing process cause the fluid being dropped or leaked on the dispensing surface.

### CROSS REFERENCE TO RELATED APPLICATION

This application claims the benefit of Taiwan Patent Application Serial No. 111102826, filed on Jan. 24, 2022, the subject matter of which is incorporated herein by reference.

### BACKGROUND OF THE INVENTION

### 1. Field of the Invention

The present invention relates to a fluid dispensing apparatus, in particular to fluid dispensing apparatus applicable to a dispensing process for a material with high viscosity coefficient. The fluid control structure provided by the present invention can serve as the switch for supplying and not supplying the fluid for the dispensing apparatus.

### 2. Description of the Prior Art

In general, a currently available dispensing apparatus usually controls the fluid supplying by air pulse or use injecting, volume calculating, a propeller, etc., according to the characteristics of the fluid. However, when the dispensing apparatus stops supplying the fluid, the fluid staying around the liquid outlet of the needle head may still flow toward the dispensing surface due to residual pressure. Accordingly, the way of supplying and stop supplying of the currently available dispensing apparatus may have the shortcoming that the thickness or amount of the fluid, staying on the dispensing area of the dispensing surface, is non-uniform.

So as to solve the above problem, some structures for the improvement of controlling fluid supplying have been developed. One preferred structure, among these structures, uses two ceramic pads for controlling fluid supplying. The major technical mean of which is to form a circular hole at the center of each of the ceramic pads so as to control fluid supplying by adjusting the relative position between the ceramic pads. When the dislocation between the axes of the two ceramic pads occurs, the structure stops supplying the fluid. On the contrary, when the axes of the two ceramic pads are coaxial, the structure supplies the fluid, which can achieve the function of immediately supplying the fluid or stopping supplying the fluid. However, this improved structure needs an additional ceramic pad control module, so the mechanical design thereof may be complicated, which would significantly increase the cost thereof.

Therefore, the inventor of the present invention, based on years of experience in the related industry, conducted extensive researches and experiments, and finally developed a fluid control structure of a dispensing apparatus in order to solve the above shortcoming of the prior art.

### SUMMARY OF THE INVENTION

To solve the aforementioned shortcoming and achieve the objective of precisely and swiftly controlling fluid supplying, the present invention provides a fluid control structurer of a dispensing apparatus.

According to one embodiment of the present invention, the fluid control structurer of the dispensing apparatus includes a dispensing unit, a fluid supply unit and a control unit. The fluid supply unit is connected to the dispensing unit to supply the fluid for a dispensing process. The control unit is connected to the fluid supply unit so as to adjust the pressure of supplying the fluid and controls the dispensing unit to perform the dispensing process.

In one embodiment of the present invention, the fluid supply unit includes a fluid supply element and a fluid chamber.

In one embodiment of the present invention, he dispensing unit includes a needle head, a thimble and a valve body. The valve body is provided with an accommodating space for accommodating the needle head and the thimble. A hollow space is formed in the needle head and one end of the needle head is provided with a nozzle. The control unit controls a transmission element to move the thimble upward and downward in the accommodating space of the valve body. In addition, the taper degree of the thimble may be equal to that of the needle head, which can achieve the function of a switch in order to control fluid supplying.

The aforementioned control unit can control moving speed and the position of the thimble, which can adjust the supplying amount of the fluid, just like a flow meter. The supplying amount of the fluid can be adjusted according to actual requirements or the fluid supplying or stopping the supplying of the fluid.

The shape of the nozzle of the needle head can be modified according to different applications and the structure design thereof can also be changed so as to improve the dispensing effect.

The shape of the aforementioned thimble can be corresponding to that of the needle head and can have different taper degree.

The dispensing apparatus according to the embodiments of the present invention can be applied to bottom filling, high-precision wafer packaging, high-speed LED phosphor filling, high-precision silver epoxy/solder paste dispensing for die bonding, LCD Tuffy protection glue dispensing, non-contact shading glue dispensing, side protection for touch panels, chip/resistor/capacitor protection for soft printed circuit boards and polyurethane reactive (PUR) fine spraying, etc.

Via the fluid control structure of the dispensing apparatus according to the embodiments of the present invention, the fluid can be swiftly and accurately dispensed at the designated positions without leaking or dripping, which can greatly improve the dispensing effect.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 shows a schematic view of use of a fluid control structure of a dispensing apparatus in accordance with one embodiment of the present invention.

FIG. 2 shows a schematic view of dispensing control in accordance with one embodiment of the present invention.

FIG. 3A shows a 3D schematic view and a sectional view of a needle head having different structure in accordance with one embodiment of the present invention.

FIG. 3B shows a 3D schematic view and a sectional view of a needle head having another different structure in accordance with one embodiment of the present invention.

FIG. 4A shows a schematic view of a thimble having different taper degree in accordance with one embodiment of the present invention.

FIG. 4B shows a schematic view of a thimble having another different taper degree in accordance with one embodiment of the present invention.

FIG. 5 shows a sectional view of an on state (supplying the fluid) of the fluid control structure in accordance with one embodiment of the present invention.

FIG. 6 shows a sectional view of an off state (stopping supplying the fluid) of the fluid control structure in accordance with one embodiment of the present invention.

FIG. 7A shows a schematic view of the shape of a glue layer dispensed by the apparatus in accordance with one embodiment of the present invention (top view).

FIG. 7B shows a schematic view of the thickness of the glue layer dispensed by the apparatus in accordance with one embodiment of the present invention (side view).

### DETAILED DESCRIPTION OF THE PREFERRED EMBODIMENT

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

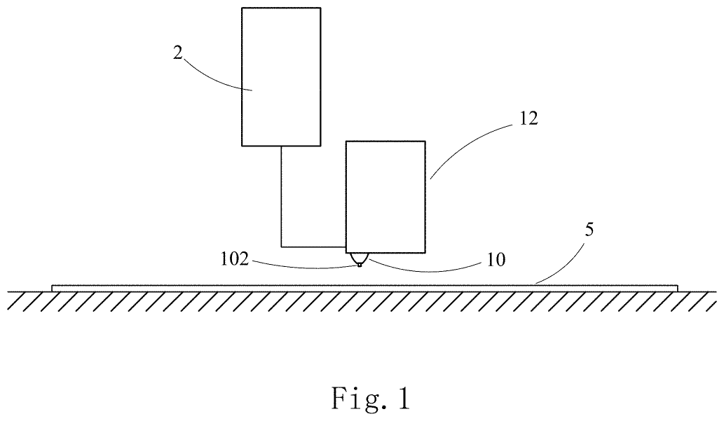

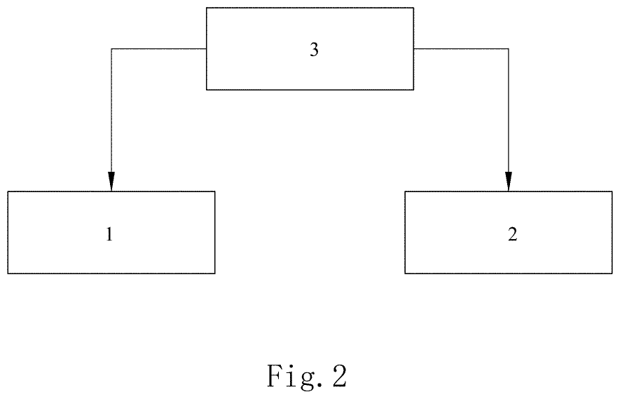

Please refer to FIG. 1 and FIG. 2, which show a schematic view of use of a fluid control structure of a dispensing apparatus and a schematic view of dispensing control in accordance with one embodiment of the present invention. The fluid control structure of the dispensing apparatus includes a dispensing unit 1, a fluid supply unit 2 and a control unit 3. The fluid supply unit 2 is connected to the dispensing unit 1 in order to supply the fluid for a dispensing process. The control unit 3 is connected to the fluid supply unit 2. The control unit 3 can adjust the pressure of supplying the fluid and the dispensing unit 1 can be controlled by the control unit 3 to perform the dispensing process.

In one embodiment, the fluid supply unit 2 includes a fluid supply element (not shown in the drawings) and a fluid chamber (not shown in the drawings). The fluid is outputted from the fluid supply element to the fluid chamber and flows from the fluid chamber to the needle head 10.

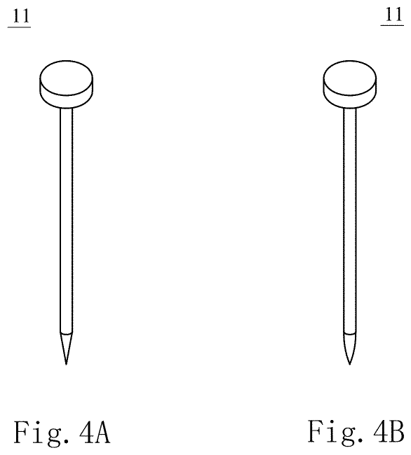

Please further refer to FIG. 4A and FIG. 4B. As shown in FIG. 4A and FIG. 4B, the dispensing unit 1 includes a needle head 10, a thimble 11 and a valve body 12. The valve body 12 is provided with an accommodating space for accommodating the needle head 10 and the thimble 11. The hollow space 101 is formed in the needle head 10 and one end of the needle head 10 is provided with a nozzle 102. The hollow space 101 of the needle head 102 is tapered towards the direction of the nozzle 102. The control unit 3 controls a transmission element (not shown in the drawings) to move the thimble 11 upward and downward in the hollow space 101 of the needle head 10. In addition, the taper degree of the thimble 11 may be equal to that of the needle head 10, which can achieve the function of a switch in order to control fluid supplying.

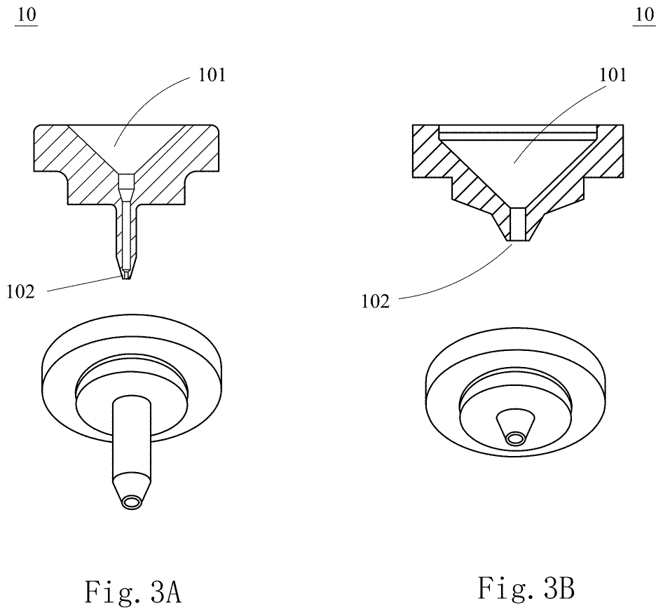

Please refer to FIG. 3A, which shows a 3D schematic view and a sectional view of a needle head having different structure in accordance with one embodiment of the present invention. As shown in FIG. 3A, the inner space of the needle head 10 is tapered towards the direction of the nozzle 102. In addition, the nozzle 102 is thin and long, which is suitable for performing the dispensing process for a narrow groove. Please refer to FIG. 3B, which shows a 3D schematic view and a sectional view of a needle head having another different structure in accordance with another embodiment of the present invention. As shown in FIG. 3B, the inner space of the needle head 10 is tapered towards the direction of the nozzle 102 and the height of the nozzle 102 is designed for general purpose, which is suitable for performing the dispensing process for a flat surface.

Please refer to FIG. 4A, which shows a schematic view of a thimble having different taper degree in accordance with one embodiment of the present invention. In this embodiment, one end, connecting to the transmission element, of the thimble 11 is cylindrical and the other end thereof is cone-shaped having a circular arc so as to match the needle head 10.

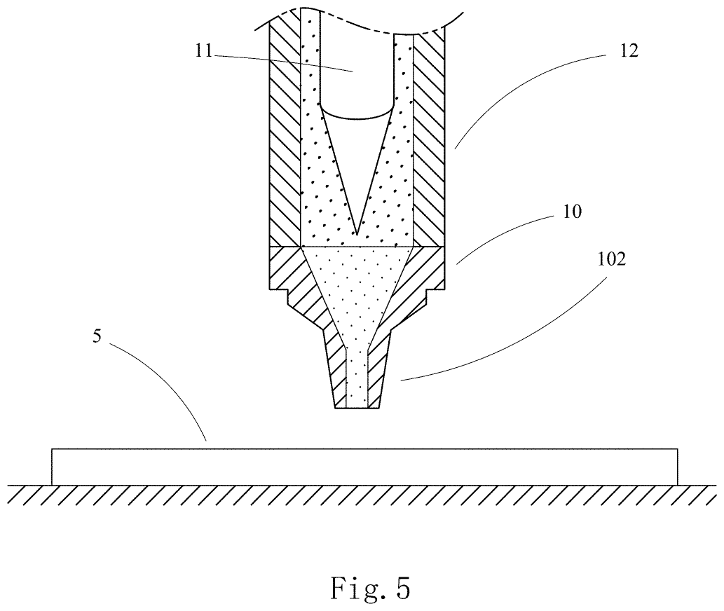

Please refer to FIG. 5, which shows a sectional view of an on state (supplying the fluid) of the fluid control structure in accordance with one embodiment of the present invention. When the fluid is connected to the nozzle 102 via the fluid chamber to execute the dispensing process, the fluid would be pushed to the fluid chamber due to the pressure (because the fluid control structure in this embodiment adopts normal pressure). In this way, the fluid in the fluid chamber flows to the nozzle 102 at the front end of the needle head 10 in order to dispense the fluid over the dispensing surface 5.

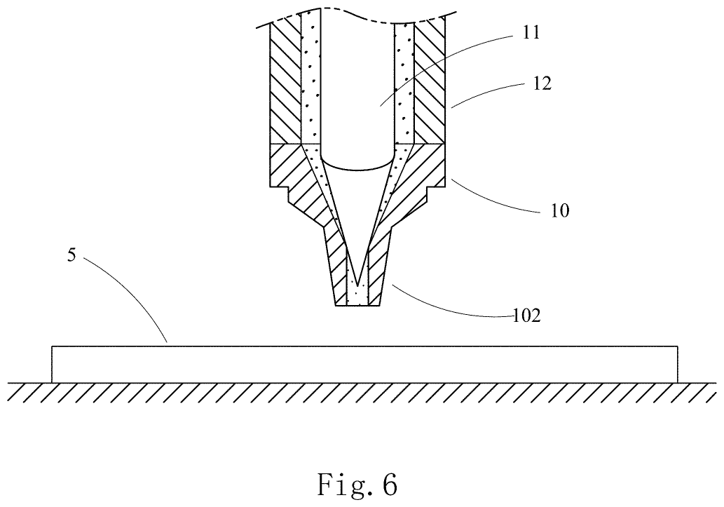

Please refer to FIG. 6, which shows a sectional view of an off state (stopping supplying the fluid) of the fluid control structure in accordance with one embodiment of the present invention. When the fluid supplying is stopped, the thimble 11 moves downward to contact the taper structure of the needle head 10. At the moment, the residual fluid on the nozzle 102 would not be pushed to the dispensing surface 5 by the thimble 11 because of the cone-shaped structure design of the thimble 11. Accordingly, the dispensing surface 5 can be smooth and flat, which can greatly improve the dispensing quality.

When the fluid control structure of the dispensing apparatus according to the embodiment of the present invention is installed on a machine, the dispensing process can be controlled by the control unit 3 via performing a program and the control unit 3 can simultaneously control the machine to horizontally move.

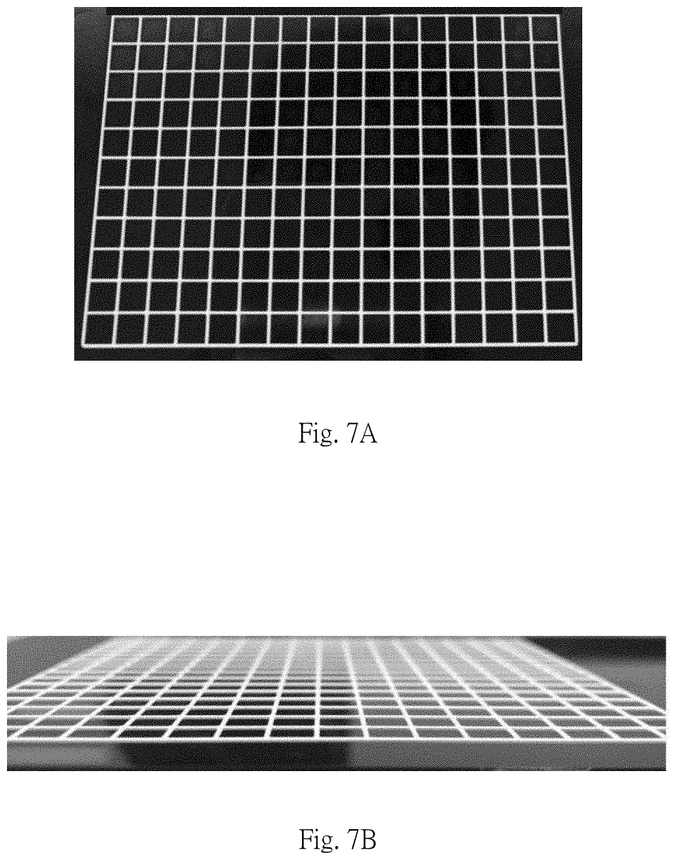

FIG. 7A and FIG. 7B show a sample finished by the fluid control structure of the dispensing apparatus according to one embodiment of the present invention in a predetermined operating area. In the dispensing process, when the dispensing apparatus executes the dispensing process for the horizontal line in an area (the vertical line in the area has been coated with the fluid) and the needle head reaches the intersection point between the horizontal line and the vertical line, the thimble moves downward and the fluid supplying is stopped. After the thimble passes through the intersection point, the thimble moves upward and the fluid supplying starts. Therefore, the fluid on the intersection pint between the horizontal line and the vertical line can be uniform and flat.

The checker dispensing result shown in FIG. 7A shows is the actual dispensing shape finished by the structural characteristics, including the taper structures of the needle head and the thimble, of the embodiment of the present invention. As shown in FIG. 7A, the glue layer is flat and uniform. FIG. 7B shows a schematic view of the thickness of the glue layer dispensed by the apparatus in accordance with one embodiment of the present invention. As shown in FIG. 7B, the glue layer is flat and uniform.

In one embodiment, the shape of the nozzle of the needle head can be replaced according to different applications.

In one embodiment, the thimble is made of ceramic material or tungsten steel.

In one embodiment, the shape of the thimble is corresponding to that of the nozzle of the needle head. The taper degree of the thimble can be changed, which may be cone-shaped or cone-shaped with a circular arc.

The above embodiment of the present invention provides an improved dispensing structure, which can achieve the control function of supplying or not supplying the fluid. Therefore, the improved dispensing structure can more accurately and swiftly perform the dispensing process.

The above disclosure is related to the detailed technical contents and inventive features thereof. Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A fluid control structure of a dispensing apparatus, comprising:
a dispensing unit, comprising a needle head, a thimble and a valve body, wherein the valve body is provided with an accommodating space for accommodating the needle head and the thimble, and a hollow space is formed in the needle head and one end of the needle head is provided with a nozzle;
a fluid supply unit, connected to the dispensing unit and configured to supply a fluid for a dispensing process; and
a control unit, connected to the fluid supply unit and configured to adjust a pressure of supplying the fluid, an amount of supplying the fluid, wherein the control unit is further connected to the dispensing unit to control a moving speed and a position of the thimble so as to perform the dispensing process.

2. The fluid control structure of the dispensing apparatus of claim 1, wherein the hollow space of the needle head is tapered towards a direction of the nozzle.

3. The fluid control structure of the dispensing apparatus of claim 2, wherein a taper degree of the thimble is equal to a taper degree of the needle head.

4. The fluid control structure of the dispensing apparatus of claim 2, wherein a taper degree of the thimble is not equal to a taper degree of the needle head.

5. The fluid control structure of the dispensing apparatus of claim 3 or claim 4, wherein a shape and a structure of the nozzle are different from a shape and a structure of the needle head.

6. The fluid control structure of the dispensing apparatus of claim 5, wherein a shape and a structure of the thimble are corresponding to the shape and the structure of the nozzle while a taper degree of the thimble is different from a taper degree of the nozzle.

7. The fluid control structure of the dispensing apparatus of claim 6, wherein the thimble is cone-shaped or cone-shaped having a circular arc.

8. The fluid control structure of the dispensing apparatus of claim 6, wherein the fluid supply unit comprises a fluid supply element and a fluid chamber.
